(19) United States
(12) Patent Application Publication
(10) Pub. No.: US 2009/0008847 A1
(43) Pub. Date: Jan. 8, 2009

(54) Height Adjustable Shock Absorber

(75) Inventor: Michael FRITZ, Breckerfeld (DE)

Correspondence Address: CROWELL & MORING LLP;INTELLECTUAL PROPERTY GROUP, P.O. BOX 14300, WASHINGTON, DC, 20044-4300, US

(73) Assignee: ThyssenKrupp Bilstein Suspension GmbH, Ennepetal (DE)

(21) Appl. No.: 12/166,106

(22) Filed: Jul. 1, 2008

(30) Foreign Application Priority Data
Jul. 2, 2007 (DE) 10 2007 030 641.7

(51) Int. Cl. B60G 13/06

(52) U.S. Cl. 267/217

(57) ABSTRACT

The invention concerns a shock absorber for motor vehicles having a vibration absorber tube (1), in which a working piston (3) is arranged which is fixed to a piston rod (2), a closure pack (16) which closes the vibration absorber tube (1), and guides the piston rod (2), along with an outer tube (4) which surrounds at least partly the vibration absorber tube (1), wherein the outer tube (4) is connected rigidly to the piston rod (2) outside the vibration absorber tube (1). In order to achieve a shock absorber whose height may be adjusted by simple means, without needing additional installation space for the shock absorber, it is proposed in accordance with the invention that at least one sealing element (15) is arranged between the vibration absorber tube (1) and the outer tube (4), that the connection between the outer tube (4) and the piston rod (2) is designed to be fluid-tight and the chamber H defined by the outer tube (4) and the vibration absorber tube (1) comprises a connector (11) for feeding in a working fluid.

The invention concerns a height adjustable shock absorber for motor vehicles in accordance with the patent claim 1 preamble.

Such shock absorbers are well known in the art. The outer tube which surrounds the vibration absorber tube at least partly serves to impart a high degree of flexural rigidity of the whole spring strut, in the case of these well known shock absorbers. In particular shock absorbers of this kind of construction are fitted in high performance sports cars. As a result these sports cars exhibit routinely only a small ground clearance, i.e. only a small gap between road surface and vehicle chassis. This small ground clearance makes it difficult, for instance, to drive over road ridges or kerb stones. This problem reduces the road capability of these kinds of cars considerably, because in particular riding over obstacles in areas possessing traffic calming devices or for example kerb stones in the area of petrol station exits, is exacerbated. Riding over such obstacles may even be impossible if the vehicle exhibits a low-level spoiler, which is routinely arranged at the front of the vehicle in the case of sports cars and has a small ground clearance.

The object of the invention is to realise a height adjustment in order to be able to vary the ground clearance of the vehicle in technically simple ways and without having to carry out changes to the installation space for the shock absorber.

This problem is solved by a shock absorber having the features according to claim 1. Further advantageous developments are cited in the subordinate claims.

The knowledge underlying the invention centres on the possibility of realising a height adjustment by simple means in the case of a shock absorber having the features according to the preamble of the patent claim 1, without having to make changes to the installation space for installing the shock absorber. On account of arranging at least one sealing element between the vibration absorber tube and the outer tube and designing the connection between the outer tube and the piston rod to be fluid-tight a sealed off chamber is produced, which is defined by the outer tube, the vibration absorber tube and the fluid-tight connection of piston rod and outer tube. A working fluid, such as for example compressed air may be fed via a connector into this sealed off chamber. This working fluid then operates upon the vibration absorber tube displaceably arranged in the outer tube, so that the vibration absorber tube is displaced within the outer tube almost in the manner of a piston. In this way the shock absorber is driven apart telescopically and the gap between the vehicle chassis and the road surface is increased.

By draining off working fluid via the connector the gap between the vehicle chassis and the road surface may then be reduced again.

In order to design the connection between the outer tube and piston rod to be fluid-tight, a closing plate welded into the outer tube at its end remote from the vibration absorber tube is provided according to the invention, which comprises a hole through which to feed the piston rod. This closing plate is preferably welded to the inner wall of the outer tube along its entire outer circumference. In the region of the hole, through which the piston rod is fed, a sealing element is arranged which is effective between the piston rod and the closing plate. In this way the chamber defined by the outer tube and the vibration absorber tube is sealed off fluid-tight against the environment.

Essentially it would also be possible to weld the closing plate over only parts of its outer circumference, rather than over the entire outer circumference of the closing plate to the inner wall of the outer tube. In this case one or more sealing elements would have to be provided, which are effective between the closing plate and the outer tube, so that the chamber is sealed off fluid-tight.

According to a first embodiment of the invention the connector through which the working fluid is fed may be arranged at the outer circumference of the outer tube.

According to a second embodiment of the invention the connector through which the working fluid is fed is arranged in the closing plate.

The invention will now be explained in more detail with the aid of drawings, in which

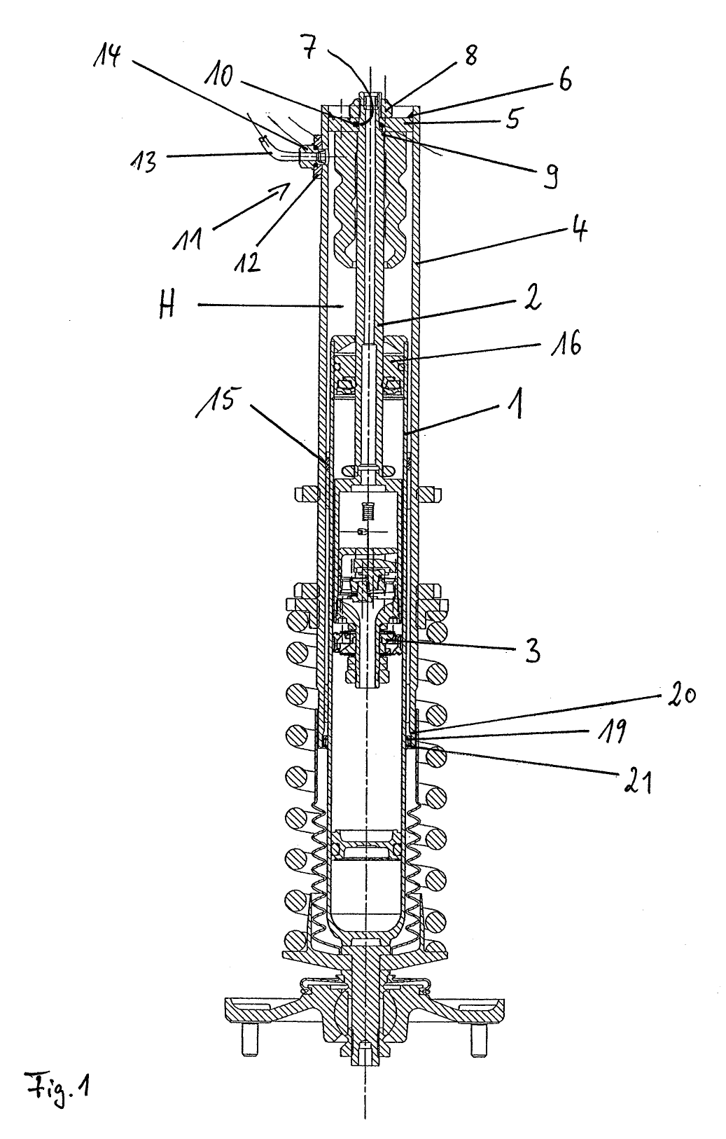

FIG. 1 shows a first embodiment of the height adjustable shock absorber;

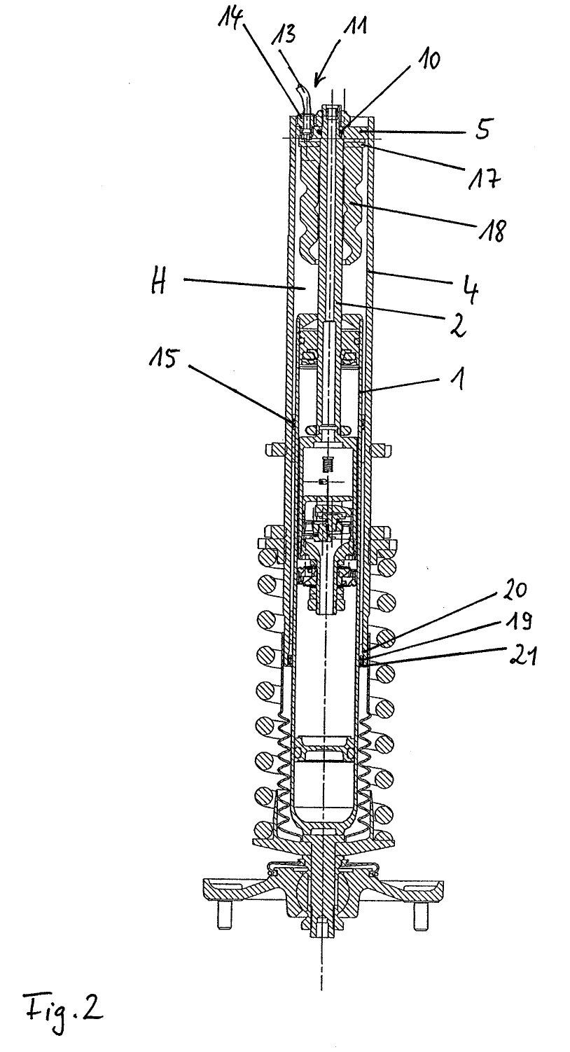

FIG. 2 shows a second embodiment of the height adjustable shock absorber modified from FIG. 1.

A height adjustable shock absorber according to a first embodiment of the invention is shown in FIG. 1. The shock absorber comprises a vibration absorber tube 1, in which a working piston 3 is arranged on a piston rod 2. The shock absorber additionally comprises an outer tube 4, which partly surrounds the vibration absorber tube 1. The outer tube 4 is closed by a closing plate 5 at its end remote from the vibration absorber tube. The closing plate 5 is welded to the inner wall of the outer tube 4 via a circumferential weld seam 6.

A hole 7 is provided in the centre of the closing plate 5, through which the piston rod 2 is driven. The piston rod 2 comprises a threaded section at its end remote from the vibration absorber tube 1, onto which a nut 8 is screwed. The piston rod 2 additionally comprises a radial shoulder 9, with which the piston rod is braced against the closing plate 5.

In this way the piston rod 2 is connected rigidly to the closing plate 5 via the nut 8 and the shoulder 9.

A groove is provided in the surface of the hole 7 in the closing plate 5 facing the piston rod 2, in which a sealing element 10, e.g. an O-ring is fitted. The chamber H defined by the outer tube 4, the vibration absorber tube 1 and the closing plate 5 is sealed off from the environment by this sealing element and the circumferential weld seam 6.

A connector 11 is arranged at the outer circumference of the outer tube 4, through which connector a working fluid such as for example compressed air may be fed into the chamber H. The working fluid is provided from a working fluid reservoir not shown. The working fluid hose 13 is connected to the working fluid reservoir at its side remote from the connector 11. Essentially a liquid working medium could also be fed into the chamber H via the connector 11. In the exemplified embodiment shown however the connector 11 is in fact a compressed air connector. An adapter 12 is arranged at the outer circumference of the outer tube 4, and the compressed air hose 13 is connected to the adapter 12 via a screw connection 14 so as to be sealed with respect to compressed air. An aperture is present in the wall of the outer tube 4, through which the working fluid flowing through the compressed air hose 13 reaches the chamber H. The adapter 12 is connected in a pressure-tight manner to the outer tube 4, e.g. by a welded, soldered or adhesive bond.

In the area in which the outer tube 4 and the vibration absorber tube 1 overlap an additional sealing element 15 is arranged, which forms an effective seal between the inner wall of the outer tube 4 and the outer wall of the vibration absorber tube 1. The chamber H is sealed off on the vibration absorber tube side by this sealing element 15. Consequently a fluid-tight sealed chamber H is produced by the weld seam 6, the sealing element 10 at the end of the outer tube 4 remote from the vibration absorber tube and the sealing element 15, which is effective between outer tube 4 and vibration absorber tube 1.

The chamber H is pressurised by feeding the working fluid into the chamber H via the connector 11. A force results from this excess pressure, which operates upon the vibration absorber tube 1 via the closing pack 16, with which the vibration absorber tube 1 is closed. Since the vibration absorber tube 1 is held in an axially displaceable manner in the outer tube 4, the shock absorber can be driven apart telescopically in this way by raising the pressure in the chamber H, so that the vehicle chassis is raised up and the ground clearance (i.e. the gap between the vehicle chassis and the road surface) is increased.

A second exemplified embodiment of the height adjustable shock absorber according to the invention is shown in FIG. 2. The components analogous to the components shown in FIG. 1 are identified with the same reference numbers.

In essence the construction of the shock absorber according to FIG. 2 corresponds to the construction of shock absorber according to FIG. 1. The difference between the two embodiments of the invention consists solely in the type and method of arranging the working fluid connector 11. In the case of the exemplified embodiment according to FIG. 2 the working fluid supply 11 is arranged at the closing plate 5 rather than at the outer circumference of the outer tube 4. For this a hole is provided in the closing plate 5, into which the working fluid hose 13 is inserted via a screw connection 14. The connection between the closing plate 5 and the outer tube 4 is effected in the same way as for the example according to FIG. 1. Also the sealing of the chamber H against the environment via the sealing element 10, which is designed as an O-ring in the exemplified embodiment, and the sealing element 15, corresponds to the embodiment according to FIG. 1.

A spacer 17 is arranged between the closing plate 5 and the compression buffer 18 so that the working fluid may reach the chamber H. This spacer 17 comprises a groove at least in the region of the working fluid connector, through which groove the working fluid can flow into the chamber H.

The operating mode of the height adjustment in the case of the exemplified embodiment according to FIG. 2 is identical to the operating mode in the case of the exemplified embodiment according to FIG. 1.

In order to support and position the sealing element 15 in the axial direction, this is e.g. pressed in and is then supported at a chamfer or shoulder on the inner wall of the outer tube 4. This chamfer or shoulder may be produced, in that the internal diameter of the outer tube 4 is designed (e.g., skimmed) to be larger seen from the side of the closing plate 5, than the remaining internal diameter of the outer tube 4. Alternatively a circlip may also be provided, which is for example inserted into a groove in the inner walls of the outer tube 4.

Optionally in the case of both the hereinabove specified embodiments of the invention an additional sealing element 19 may be arranged at the end of the outer tube remote from the closing plate 5 additional to the sealing element 15, which causes the chamber H to be pressure-tight. This sealing element 19 is in turn effective between the inner wall of the outer tube 4 and the outer wall of the vibration absorber tube 1 and has the task of wiping off dirt from outside. In order to support the sealing element 19 in the axial direction a radial shoulder 20 is arranged on the inner walls of the outer tube 4 on the one hand, and a circlip 21 is provided on the other hand, which is inserted into a groove in the inner walls of the outer tube 4.

Furthermore in a third embodiment of the invention not shown in the figures there is the possibility of dispensing with the sealing element 15 and providing only the sealing element 19. In this event the sealing element must wipe off dirt from outside on the one hand, and on the other hand the sealing element 19 must guarantee the fluid-tight sealing off, which the sealing element 15 had undertaken in the previously specified exemplified embodiments.

The sealing element 19 in this case must ensure a seal between the outer tube 4 and the vibration absorber tube 1. If the sealing element 15 is dispensed with and if only the sealing element 19 is provided on the side facing the vibration absorber tube 1, the chamber H will be larger than in the case of the exemplified embodiments with damping [sic] element 15. A larger chamber H may be needed if the situation arises, if too great a pressure would ensue in the chamber H defined by the sealing element 15 when the vibration absorber is in compression.

1. Shock absorber for motor vehicles having a vibration absorber tube, in which a working piston is arranged which is fixed to a piston rod, a closing pack which closes the vibration absorber tube and guides the piston rod, along with an outer tube which surrounds at least partly the vibration absorber tube, wherein the outer tube is connected rigidly to the piston rod outside the vibration absorber tube, wherein at least one sealing element is arranged between the vibration absorber tube and the outer tube, that the connection between the outer tube and the piston rod is designed to be fluid-tight and the chamber defined by the outer tube and the vibration absorber tube comprises a connector for feeding in a working fluid.

2. The shock absorber according to claim 1, wherein a closing plate is welded into the outer tube at its end remote from the vibration absorber tube, which closing plate comprises a hole through which the piston rod is guided, and that a sealing element which is effective between the piston rod and the closing plate is arranged in the area of the hole.

3. The shock absorber according to claim 1, wherein the connector is arranged at the outer circumference of the outer tube.

4. The shock absorber according to claim 2, wherein the connector is arranged on the closing plate.
